(19) United States
(12) Patent Application Publication
(10) Pub. No.: US 2007/0080540 A1
(43) Pub. Date: Apr. 12, 2007

(54) HYDRAULIC BUOYANCY KINETIC ENERGY APPARATUS

(76) Inventor: Jui-Chi Tung, Taichung City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/247,928

(22) Filed: Oct. 10, 2005

(51) Int. Cl. F03B 13/00; F03B 13/10; H02P 9/04

(52) U.S. Cl. 290/43

(57) ABSTRACT

A hydraulic buoyancy kinetic energy apparatus includes two buoys which are located at an upper position and a lower position respectively. A chain is connected between the two buoys so as to alternatively move the two buoys. Water inside a water tank fills an air storage cylinder to push the air into the lower buoy to produce buoyancy to float upward, and the upper buoy gradually fills up with water to produce a gravitational force and to force air into air storage hood. Since air is introduced from an air duct into the air storage cylinder from the air storage hood, the two buoys are moved alternatively up and down to link an electric generating set as a motive power source for generating electric power.

### FIELD OF THE INVENTION

The present invention relates to an electric power generator, and more particularly to a hydraulic buoyancy kinetic energy apparatus that uses the interactions between water pressure and air buoyancy to produce kinetic energy of an electric generator and discharges a minimum quantity of water.

### BACKGROUND OF THE INVENTION

Referring to FIGS. 9 and 10, a prior art air buoyancy electric generator uses an air compressor 1 to store the compressed air into a steel cylinder 3 through a duct 2 connected to the steel cylinder 3, and installs a water tank 4 which is filled up with water. The compressed air in the steel cylinder 3 is discharged through a duct 5 connected to a water tank 4 out from an air outlet 6 of the duct 5 at the bottom of the water tank 4. The discharged air is injected into an air chamber 8 disposed on the surface of the caterpillar band 7. In the meantime, a buoyancy will be produced to rotate the caterpillar band 7 installed between an upper transmission shaft 91 and a lower transmission shaft 92, so that the upper transmission shaft 91 drives an electric generator 93 to rotate and produce electric power.

The foregoing prior art injects compressed air into an air chamber 8 to produce buoyancy, and uses the buoyancy to provide a rise of kinetic energy and drive the electric generator. Before this prior art generates electric power, it is necessary to consume power to run the air compressor to produce compressed air. In other words, the electric generator is useless without a power source. After the electric power is generated, it is necessary to consume part of the power to drive the air compressor, and thus decreasing the quantity of the generated electric power. The kinetic energy or power cannot be stored completely.

The inherent shortcoming for the prior art is that energy is used to drive the compressor to compress the air for the buoyancy so that the energy is a negative value before the electrical power is generated. Furthermore, the conventional compressor cannot be used if there is no existed power supply.

### SUMMARY OF THE INVENTION

The hydraulic buoyancy kinetic energy apparatus of the present invention includes two buoys which are located at an upper position and a lower position respectively. A chains is connected between two chain wheels which include two respective one-way bearings in opposite directions so as to alternatively move the two buoys to output the water pressure inside a water tank to an air storage cylinder to push the air into the lower buoy, so that the buoy produces a buoyancy to float upward, and upper buoy gradually fills up with water to produce a gravitational force. Since the air is introduced from an air duct into the air storage cylinder, such that the two buoys are moved alternatively up and down to link an electric generating set as a motive power source for generating electric power.

It is a primary objective of the present invention to provide an apparatus that does not require any equipment to produce air for supplying the buoy, and the apparatus can achieve the ascending or descending movements, so as to achieve the effect of generating electric power. The invention does not need additional motive power source or waste any power to produce the motive power and completely convert the motive power into the electric power. Only water in the air storage cylinder is discharged to complete the circulation, and the discharged water can be used repeatedly. The invention can be used in any place with a water source to generate electric power.

### BRIEF DESCRIPTION OF THE DRAWINGS

FIG. 1 is a cross-sectional front view of the invention;

FIG. 2 is a cross-sectional side view of the invention;

FIG. 3 is a cross-sectional top view of the invention;

FIG. 4 is a schematic view of the position of two buoys of the invention;

FIG. 5 is a schematic view of tying a rope according to the invention;

FIG. 6 is a schematic view of the actions of a buoy of the invention;

FIG. 7 is a schematic view of a gravitational kinetic energy apparatus according to a preferred embodiment of the invention;

FIG. 8 is a schematic view of the actions of a gravitational kinetic energy apparatus according to a preferred embodiment of the invention;

FIG. 9 is a front view of a prior art air buoyancy electric generator; and

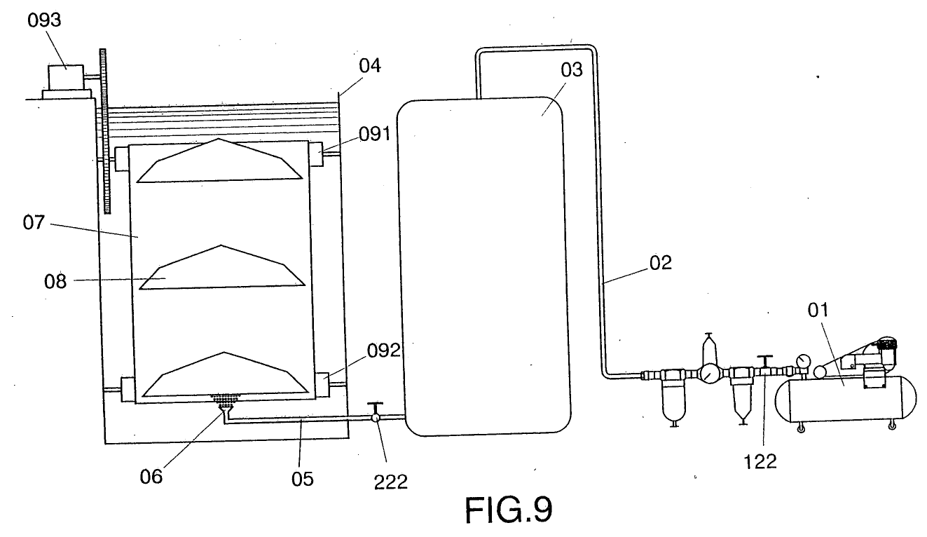

FIG. 10 is a side view of a prior art air buoyancy electric generator.

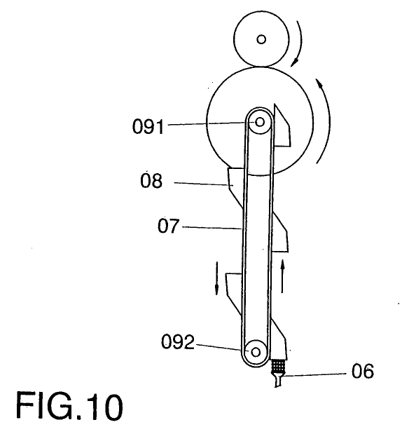

### DETAILED DESCRIPTION OF THE PREFERRED EMBODIMENTS

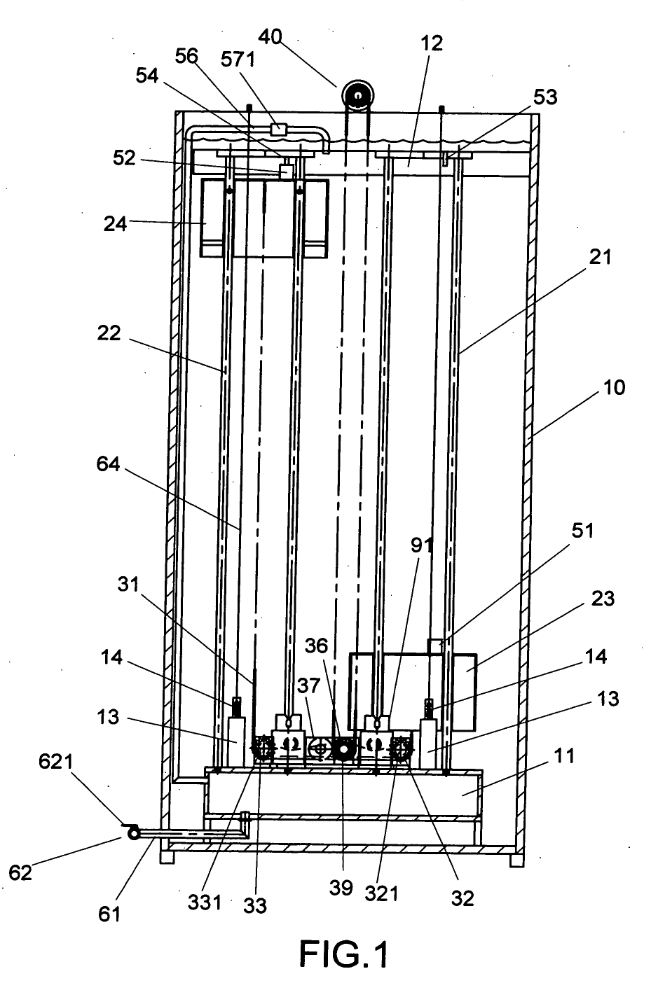

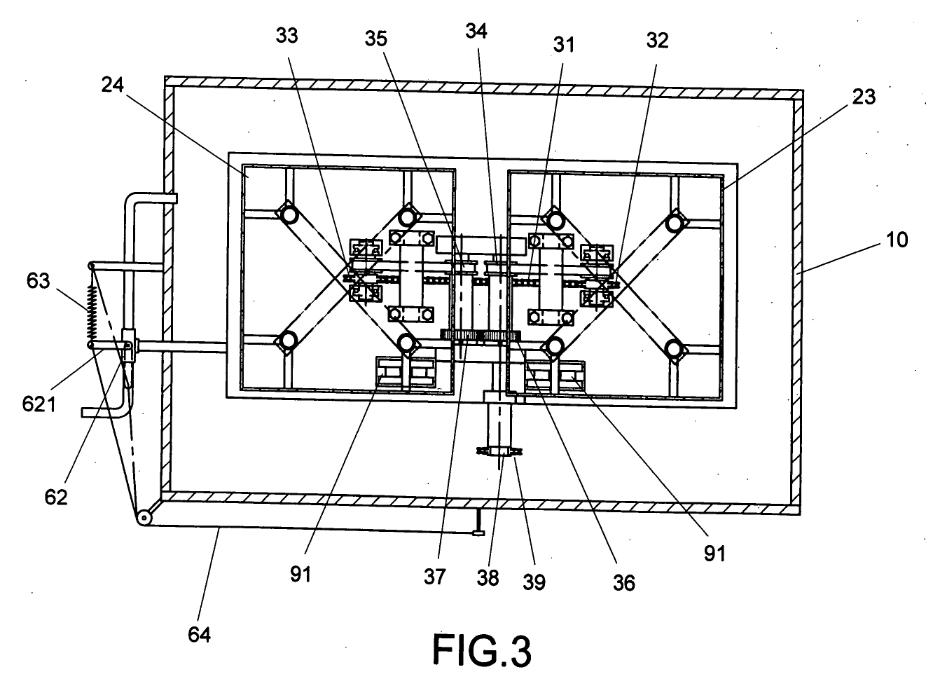

Referring to FIGS. 1 to 3, a hydraulic buoyancy kinetic energy apparatus of the invention comprises a water tank 10, an air storage cylinder 11 disposed at the bottom of the water tank 10, a slippery pillar set 21, 22 installed between the air storage cylinder 11 and an air storage hood 12 at the top for containing two buoys 23, 24, a chain 31 connected to the two buoys 23, 24 by a chain 31 and wound around two chain wheels 32, 33 on the air storage cylinder 11, and a one-way bearing installed between the two chain wheels 32, 33. The one-way bearings of the two chain wheels 32, 33 are installed in opposite directions, so that when the chain 31 slides up and down, only a single chain wheel is rotated as shown in FIG. 3. Axles 321, 331 of the two chain wheels 32, 33 are linked by a belt pulley set 34, 35 to the mutually engaged gears 36, 37, and one gear 36 is connected to an output shaft 38, and the chain wheel 39 of the output shaft 38 is linked with an electric generating set 40.

The top of the foregoing buoy 23, 24 includes a one-way valve 51, 52 corresponding to the top of the trigger pipe 53, 54, and the top of the air storage hood 12 is connected to the bottom of the air storage cylinder 11 by an air duct 56, and the air duct 56 includes a one-way valve 571 to prevent the pressure of the air storage cylinder 11 at the bottom to flow back to the air storage hood 12 at the top. The air storage cylinder 11 includes a pipe 61 extended to the exterior of the water tank 10 and in turn connected to the water tank 10, and the pipe 61 uses a three-way globe valve 62 to selectively turn on or off the pipe 61 (and also the water tank 10 and air storage cylinder 11, and the handle 621 of the global valve 62 connects another side of the rope 64 by a resilient member 63, and the rope 64 is wound around the link rod 14 of the one-way valve 13 at the top of the air storage cylinder 11 from the top of the water tank 10, and the rope 64 is wound around the pulley set 65 between the edges of the buoys 23, 24, and thus the buoy 23, 24 presses the rope 64 to drive the globe valve 62.

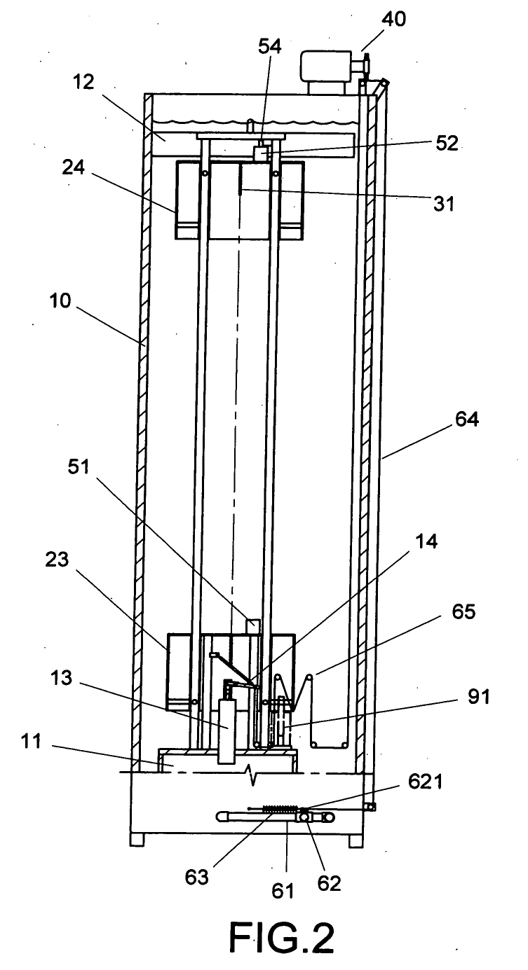

The actions of the first half cycle of the buoys are described as follows. Referring to FIGS. 1 to 3 for the water tank 10 which is filled up with water, a buoy 23 is situated at the lowest position since the interior is filled up with water, and another buoy 24 is situated at the highest position since the interior is filled up with air. If the buoy 23 is descended to the lowest position, the edge of the buoy 23 will press the rope 64 (as shown in FIG. 2), the rope 64 drives the one-way valve 13 at the top of the air storage cylinder 11, and the link rod 14 opens the one-way valve 13. In the meantime, another end of the rope 64 pulls the globe valve 62, so that the pipe 61 is turned on, and the water in the water tank 10 is discharged into the air storage cylinder 11 by the water pressure to compress the air inside. Since the one-way valve 13 is turned on synchronously, the air gradually pushes the water into the buoy 23, and the water in the buoy 23 will be compressed by the air and discharged into the water tank 10 from the bottom of the buoy 23, until the air fills up the buoy 23 and the buoy 23 is separated from the clamping of an elastic clamp 91, and the buoy 23 floats.

The buoy 24 situated at the highest position is filled up with air. Since the one-way valve 52 at the top of the buoy 24 is propped open by the trigger pipe 54 to define an open status, so that the air inside the buoy 24 will flow into the air storage hood 12 at the top. Now, the water in the water tank 10 also synchronously flows into the buoy 24 and compresses the air into the air storage hood 12, until all of the air is discharged out of the buoy 24, and the water also fills up the buoy 24.

If the foregoing air storage hood 12 at the top is situated under water, the air storage hood 12 will be filled up with water. If the air flows from the buoy 24 into the air storage hood 12, the water in the air storage hood 12 will be discharged, and the air will remain in the air storage hood 12. Since the bottom of the air storage cylinder 11 has a larger pressure when the water is discharged, therefore the one-way valve 571 can prevent the air at the bottom from flowing back into the air storage hood 12 at the top.

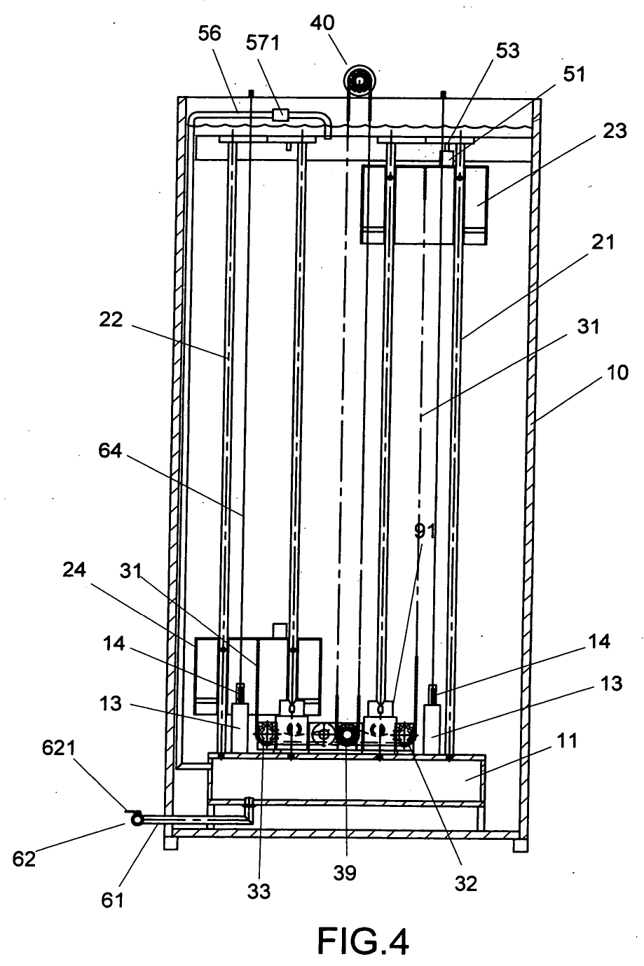

If the buoy 23 situated at the lowest position floats upward, the chain 31 synchronously pulls another buoy 24 situated at the highest position to sink until the positions of the two buoys 23, 24 are switched as shown in FIG. 4. When the chain 31 moves, it also drives the belt pulley set 34, 35 since the two chain wheels 32, 33 are installed at the one-way bearing. Only one side of the chain wheel 32 is moved (and the side of the floating position of the buoy 23), and the other chain wheel 33 produce an idle run, and thus the rising buoy 23 will drive the belt pulley set 34 to link the output shaft 38 and further the chain wheel 39 drives the electric generating set 40 to act as the motive power source for generating electric power.

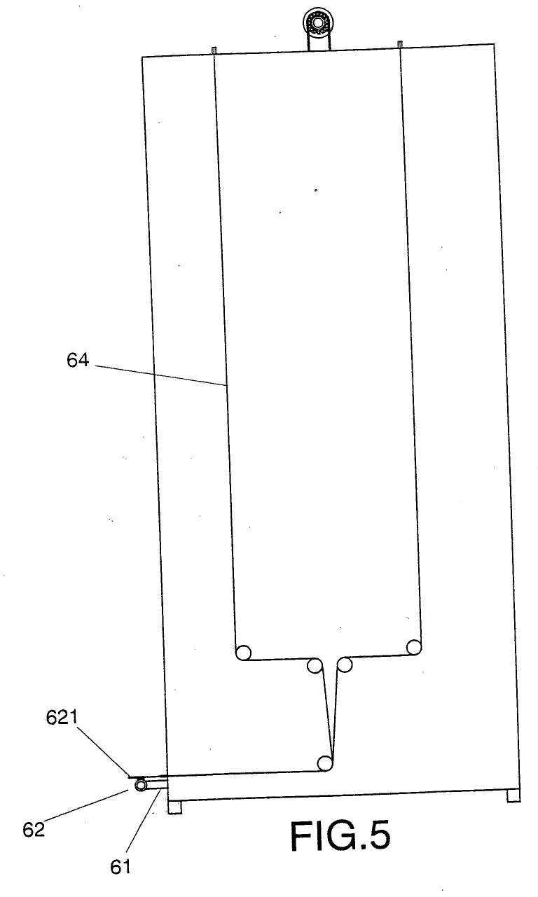

Referring to FIGS. 3 to 5, the edge of the buoy 24 will separate the rope 64 when the buoy 23 situated at the lowest position is floating upward, and the globe valve handle 621 at the other end of the rope 64 is pulled by the resilient member 63 to resume its position, so that the water tank 10 and the pipe 61 are in the off status, and the air storage cylinder 11 is in the on status. Therefore, the water accumulated in the air storage cylinder 11 will be discharged, and the pressure at the bottom of the air storage cylinder 11 will be dropped. By the water pressure, the air in the air storage hood 12 at the top will be discharged synchronously into the bottom of the air storage cylinder 11 to complete the actions of the first half cycle of the buoys.

The actions of the second half cycle of the buoys are described as follows. Referring to FIG. 4, the actions of the second cycle of the buoys of the present invention is the same as those of the first cycle. While the buoy 23 is floating upward, the chain 31 simultaneously drives the buoy 24 at another position to sink. If the buoy 23 floats to the highest position, the one-way valve 51 at the top of the buoy 23 is propped by the trigger pipe 53 into an on status, so that the air in the buoy 23 flows into the air storage hood 12 at the top. Now, the water in the water tank 10 synchronously flows into the buoy 23 to compress the air into the air storage hood 12 until all of the air is discharged from the buoy 23, and water is filled up in the buoy 23.

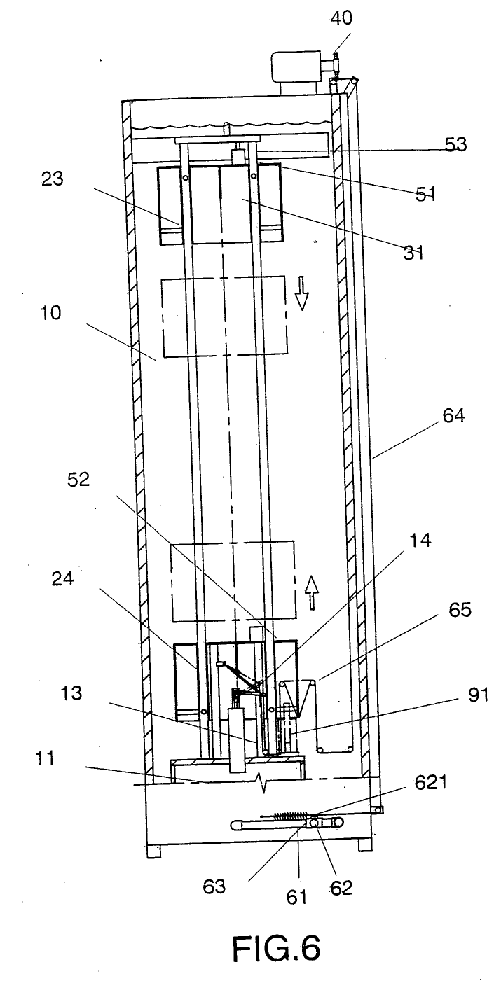

When another buoy 24 sinks synchronously to the lowest position, the buoy 24 is held in a fixed position by an elastic clamp 91 as shown in FIG. 6, and the edge of the buoy 24 will latch the rope 64 as shown in FIG. 6, and the rope 64 drives the one-way valve 13 at the top of the air storage cylinder 11, and the link rod 14 opens the one-way valve 13. In the meantime, another end of the rope 64 pulls the globe valve 62 to turn on the pipe 61, and the water in the water tank 10 is discharged into the air storage cylinder 11 by the water pressure to compress the air inside. Since the one-way valve is opened synchronously, the air is compressed gradually into the buoy 24 by the air, and the water in the buoy 24 compresses the air from the bottom of the buoy 24 and is discharged to the water tank 10 until the buoy 24 is filled up with air, and separated from the elastic clamp 91 to float upward.

If the buoy 24 at the lowest position is floating upward, the edge of the buoy 24 will be separated from the rope 64, and a globe valve handle 621 at another end of the rope 64 is pulled by the resilient member 63 to resume its position, so that the water tank 10 and the pipe 61 are in an OFF status, and the air storage cylinder 11 is in an ON status. Therefore, the water accumulated in the air storage cylinder 11 will be discharged, and the pressure of the air storage cylinder 11 will be dropped lower than the pressure of the air storage hood 12. Now, the air in the air storage hood 12 at the top will synchronously push the one-way valve 571 and the air will be discharged from the bottom of the air storage cylinder 11, so as to complete the actions of the second half cycle of the buoys. In the meantime, the chain 31 also drives the belt pulley set 35. Since the two chain wheels 32, 33 install a one-way bearing, only one chain wheel 33 moves (and the side of the floating position of the buoy 24, and the other chain wheel 32 produces an idle run. Therefore, the rising buoy 24 will drive the belt pulley set 35 to link with the gear 37 and change the rotary direction, and thus driving the output shaft 38 to rotate and further linking the chain wheels 39 to drive the electric generating set 40 to rotate. Such actions are repeated to continuously drive the electric generating set 40 to rotate and generate electric power.

The operations of a gravitational kinetic energy apparatus according to a preferred embodiment of the invention are described as follows:

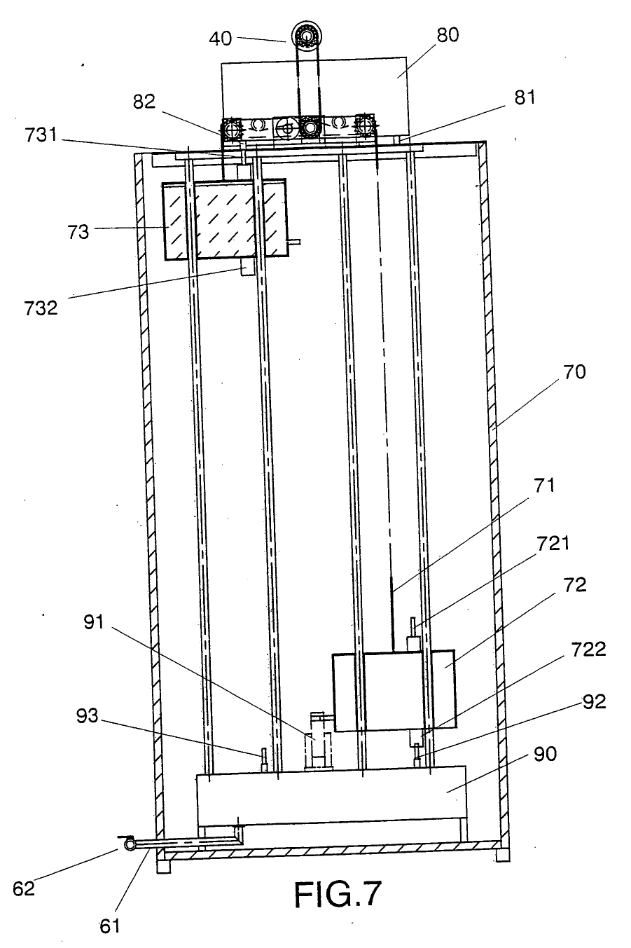

Referring to FIG. 7, the buoyancy kinetic energy apparatus of the invention is installed upside down to form a “gravitational kinetic energy apparatus” which can also be used to drive the electric generating set 40 to generate electric power. In FIG. 7, a box 70 includes two containers 72, 73 connected by a chain 71, and the two containers 72, 73 separately have a trigger pipe 721, 731 corresponding to one-way valve 81, 82 of a water storage tank 80 installed at the top of the box 70. The bottoms of the two containers 72, 73 separately include a water discharge valve 722, 732. If the container 73 is situated at the highest position, the trigger pipe 731 triggers the one-way valve 82, so that the water in the water tank 80 flows into the container 73, and another container 72 situated at the lowest position is clamped by the elastic clamp 91. If the water discharge value 722 disposed at the bottom of the container 72 which is filled up with water touches the water discharge trigger pipe 92 at the bottom, the water in the container 72 will be discharged into the water tank 90 at the bottom, and further discharged from the box 70 at an appropriate time. If the container 73 situated at the highest position and filled up with an appropriate quantity of water to provide a gravitational force, the water in the container 72 at the lowest position will be discharged completely, and the container 73 is pulled by the chain 71 to separate from the elastic clamp 91, so that the container 73 at the highest position descends, and the container 72 at the lowest position rises, and the chain 71 also drives the electric generating set 40 to operate and generate electric power.

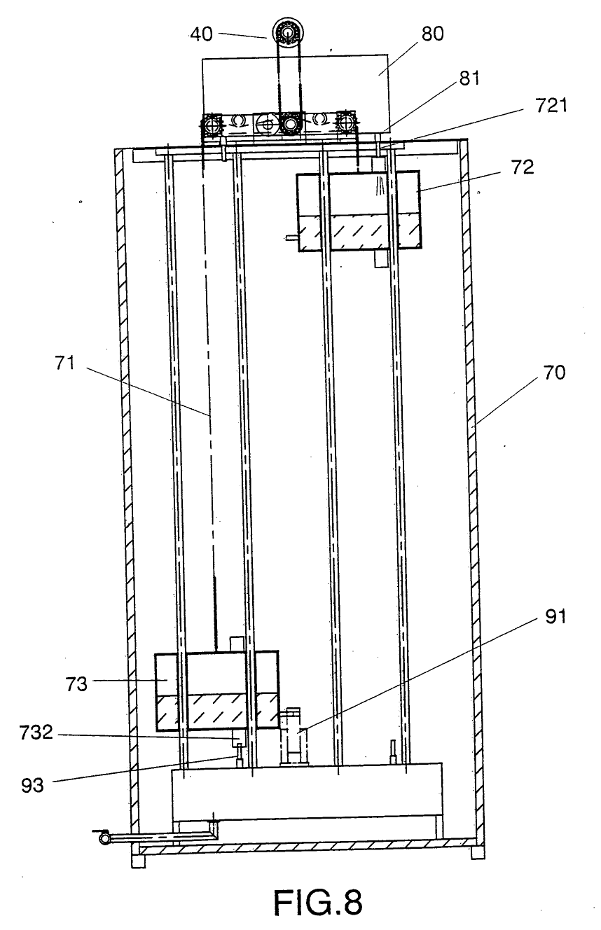

Referring to FIG. 8, the two containers 72, 73 separately reach the highest and lowest positions as described in the foregoing actions. If the trigger pipe 721 of the container 72 at the highest position triggers the one-way valve 81, the water in the water storage tank 80 will flow into the container 72. If the other container 73 at the lowest position is clamped by the elastic clamp 91 and the water discharge valve 732 installed at the bottom of the container 73 touches the bottom of the water discharge trigger pipe 93, the water in the container 73 will be discharged into the bottom of the water storage tank 90 and discharged from the box 70 at an appropriate time. If the container 72 at the highest position and filled with an appropriate quantity of water provides a gravitational force, the water in the container 73 at the lowest position will be discharged completely. Another container 72 is pulled by the chain 71 and separated from the elastic clamp 91, so that the container 72 at the highest position drops and the container 73 at the lowest position rises. In the meantime, the chain 71 drives the electric generating set 40 to operate and generate electric power.

The foregoing actions are repeated to continuously produce kinetic energy and generate electric power. This preferred embodiment does not require any kinetic energy equipments to produce kinetic energy, but the embodiment just discharges the water in the container to keep the operations going, and thus the present invention can be used in any place with a water source to continuously operate the hydraulic buoyancy electric generating apparatus and generate electric power.

1. A hydraulic buoyancy kinetic energy apparatus comprising:
a water tank having a top and a bottom;
an air storage cylinder located adjacent the bottom of the water tank;
an air storage hood adjacent the top of the water tank;
an air air duct providing air flow from the air storage hood to the air storage cylinder but preventing air flow from the air storage cylinder to the air storage hood;
first and second buoys moveable alternatively between the air storage hood and the air storage cylinder, with each of the first and second buoys including a one way valve to release air to the air air storage hood;
first and second valves on the air storage cylinder to release air into the first and second buoys respectively;
a globe valve to release water from the air storage cylinder; and
an electric generating set, with the first and second buoys being linked to the electric generating set such that the two buoys moving alternatively up and down act as a motive power source for the electric generating set.

2. The hydraulic buoyancy kinetic energy apparatus of claim 1 further comprising: a slippery pillar set disposed between the air storage cylinder and the air storage hood for containing the first and second buoys, and a chain disposed between the first and second buoys, with the chain connected and wound around two chain wheels on the air storage cylinder, and an axle of the two chain wheels links a belt pulley set to two mutually engaged gears, with one of the mutually engaged gears coupled to an output shaft, and a chain wheel of the output shaft is linked to the electric generating set;
the one-way valve is disposed at a top of each of the first and second buoys and corresponding to a trigger pipe of the air storage hood, wherein the air storage cylinder is extended to the exterior of the water tank by a pipe and in turn coupled to the water tank, and the pipe is turned on and off selectively by the globe valve, with a handle of the globe valve coupled to a rope, and with the rope attached to a link rod at the top of the air storage cylinder, and the rope is wound around a pulley set between the periphery of the buoy, so that the buoy latches the rope to drive the globe valve.

3. The hydraulic buoyancy kinetic energy apparatus of claim 2, wherein the two chain wheels on the air storage cylinder each include a one-way bearing, and the one-way bearings of the two chain wheels are installed in an opposite direction, such that when the chain moves up and down, only one of the chain wheels is driven to rotate.

4. A gravitational force kinetic energy apparatus, comprising a box having a top and a bottom, two containers coupled by a chain, with the two containers separately including a trigger pipe corresponding to a one-way valve installed at a top of a water storage tank disposed at the top of the box, wherein a bottom of the two containers includes a water discharge valve, the bottom of the box includes a water storage tank, and a top of the water storage tank includes a water discharge trigger pipe, so that one of the two containers at a highest position descends according to water accumulated in the water storage tank at the top of the box, and the other of the two containers is linked, and the chain simultaneously drives a electric generating set to operate and generate electric power.
